(19) United States
(12) Patent Application Publication
(10) Pub. No.: US 2019/0367799 A1
(43) Pub. Date: Dec. 5, 2019

(54) PROCESS AND COMPOSITION FOR REMOVING METAL SULFIDES

(71) Applicant: Baker Hughes, a GE company, LLC, Houston, TX (US)

(72) Inventors: D.V. Satyanarayana Gupta, The Woodlands, TX (US); Sandra L. Berry, Fulshear, TX (US); Andrea Nino-Penaloza, Spring, TX (US); Elizabeth McCartney, League City, TX (US); Sunder Ramachandran, Sugar Land, TX (US); Carlos M. Menendez, Houston, TX (US)

(73) Assignee: Baker Hughes, a GE company, LLC, Houston, TX (US)

(21) Appl. No.: 16/334,093

(22) PCT Filed: Sep. 26, 2017
(86) PCT No.: PCT/US2017/053384

§ 371 Date: Mar. 18, 2019

Related U.S. Application Data
(60) Provisional application No. 62/399,778, filed on Sep. 26, 2016.

(51) Int. Cl. C09K 8/532; C09K 8/54; E21B 37/00; E21B 41/02

(52) U.S. Cl. CPC C09K 8/532; C09K 8/54; C09K 2208/32; E21B 41/02; C09K 2208/20; E21B 37/00

(57) ABSTRACT

A method of removing a metal sulfide deposit from a downhole environment comprises introducing into a subsurface well a treatment fluid comprising an alkane sulfonic acid, a dispersant, and a hydrogen sulfide scavenger; contacting a metal sulfide deposit in the downhole environment with the treatment fluid; and removing the metal sulfide deposit from the downhole environment.

### CROSS REFERENCE TO RELATED APPLICATIONS

This application claims the benefit of U.S. Application No. 62/399,778, filed on Sep. 26, 2016, which is incorporated herein by reference in its entirety.

### BACKGROUND

Metal sulfides deposition is a common problem in sour oil and gas wells. The precipitation of metal sulfides in the formation matrix and around screens and perforations can decrease production capacity. Accumulation of metal sulfides in the production pipes can result in reduced well deliverability. The build-up of metal sulfides could also interfere with the operation of pumps, valves and other associated equipment. Downhole blockages also slow the flow of fluids thereby creating flow assurance issues.

Mechanical methods such as drilling, milling, and jetting may be used to remove metal sulfides. However, mechanical removal methods can be costly or ineffective under certain circumstances. Hydrogen chloride is known to be an efficient dissolver of metal sulfides deposits, including iron sulfide deposits. However, hydrogen chloride can corrode wellbore tubulars, completions, and pipelines. In addition, hydrogen chloride has a high vapor pressure and a very low pH, which may pose HSE risks if not handled properly. Accordingly, there is a continuing need in the art for alternative chemical methods that are effective and efficient to remove metal sulfides from wellbores and pipelines without the need for mechanical removal tools. It would be a further advantage if the alternative methods use environmentally friendly materials.

### BRIEF DESCRIPTION

A method of removing a metal sulfide deposit from a surface comprises contacting the metal sulfide deposit with a treatment fluid comprising an alkane sulfonic acid, a dispersant, and a hydrogen sulfide scavenger for a sufficient amount of time to dissolve the metal sulfide deposit; and removing the metal sulfide deposit from the surface.

A method of removing a metal sulfide deposit from a downhole environment comprises introducing into a subsurface well a treatment fluid comprising an alkane sulfonic acid, a dispersant, and a hydrogen sulfide scavenger; contacting a metal sulfide deposit in the downhole environment with the treatment fluid; and removing the metal sulfide deposit from the downhole environment.

Also disclosed is a treatment composition comprising an alkane sulfonic acid; a dispersant; and a hydrogen sulfide scavenger.

### DETAILED DESCRIPTION

The inventors hereof have found efficient and effective metal sulfide treatment fluids that can effectively and efficiently remove metal sulfide deposits such as iron sulfide deposits and zinc sulfide deposits without the help of mechanical removal tools. The novel treatment fluids feature the combination of a low corrosive and biodegradable alkane sulfonic acid with a dispersant that secures suspension and flow back of all removed scale deposits. The treatment fluids also contain a hydrogen sulfide scavenger that ensures the safe application of the treatment fluids. Without wishing to be bound by theory, it is believed that the alkane sulfonic acid reacts with the metal sulfide deposits, for example iron sulfide or zinc sulfide, producing hydrogen sulfide gas and small solid particulates. These small particulates are kept in the treatment fluids by the dispersant present in the treatment fluids. The hydrogen sulfide scavenger forms stable complexes with sulfide ions coming from the hydrogen sulfide gas to prevent re-precipitation of metal sulfides, for example iron sulfide. An iron control agent is optionally included in the fluid system. The iron control agent along with the hydrogen sulfide scavenger controls the precipitation of free sulfur and further precipitation of metal sulfides, for example iron sulfide.

The alkanesulfonic acid is of the general formula R—SO₃H, wherein R is a straight chain, branched, or cyclic C₁₋₆ alkyl, specifically C₁₋₄ alkyl. In an embodiment, the alkanesulfonic acid comprises methanesulfonic acid having the formula CH₃—SO₃H. Suitable methanesulfonic acid is commercially available from BASF with the tradename BASO MSA. The treatment fluids contain about 10 vol. % to about 50 vol. %, about 15 vol. % percent to about 40 vol. %, or about 17 vol. % to about 35 vol. % of the alkanesulfonic acid, based on the total volume of the treatment fluids.

The dispersant used may be cationic, anionic or non-ionic. Any dispersant that is useful for dispersing water insoluble particulates so that they do not precipitate in the treatment fluids may be used, provided that the dispersant does not interact adversely with the alkane sulfonic acid, the hydrogen sulfide scavenger, or any other components in the treatment fluids.

Exemplary dispersants include, but are not limited to mono-ethylene glycol n-hexyl ether; ethylene glycol monobutyl ether; di- and tri-propylene glycol derivatives of propyl and butyl alcohol; mono-propylene glycol mono-propyl ether; di-propylene glycol mono-propyl ether; mono-propylene glycol mono-butyl ether, di-propylene glycol mono-propyl ether, di-propylene glycol mono-butyl ether; tri-propylene glycol mono-butyl ether; ethylene glycol mono-butyl ether; di-ethylene glycol mono-butyl ether, ethylene glycol mono-hexyl ether; di-ethylene glycol mono-hexyl ether; 3-methoxy-3-methyl-butanol; and combinations thereof.

Polymeric dispersants may also be used. For example, ethoxylated long chain and/or branched alcohols, ethoxylated carboxylic acids, and ethoxylated nonylphenols having from about 2 to about 11 ethylene oxide (EO) units, ethoxylated long chain and branched alcohols, ethoxylated carboxylic acids, and ethoxylated esters of glycerol may be useful with some embodiments of the methods of the disclosure. In an embodiment, the dispersants are aqueous solutions with active ingredients comprising salts or esters of carboxylic acids or with active ingredients comprising poly alkylated or polyacrylated amides of halogen ammonium salts for example polymethacrylamidopropyl trimonium chloride.

The dispersants normally are surfactants. The surfactants described herein below can be used as dispersants.

Useful surfactants include fatty acids of up to 22 carbon atoms such as stearic acids and esters and polyesters thereof, poly(alkylene glycols) such as poly(ethylene oxide), poly(propylene oxide), and block and random poly(ethylene oxide-propylene oxide) copolymers such as those marketed under the trademark PLURONIC by BASF. Other surfactants include polysiloxanes, such as homopolymers or copolymers of poly(dimethylsiloxane), including those having functionalized end groups, and the like. Other useful surfactants include those having a polymeric dispersant having poly(alkylene glycol) side chains, fatty acids, or fluorinated groups such as perfluorinated C₁₋₄ sulfonic acids grafted to the polymer backbone. Polymer backbones include those based on a polyester, a poly(meth)acrylate, a polystyrene, a poly(styrene-(meth)acrylate), a polycarbonate, a polyamide, a polyimide, a polyurethane, a polyvinyl alcohol, or a copolymer comprising at least one of these polymeric backbones. Additionally, the surfactant is anionic, cationic, zwitterionic, or non-ionic.

Exemplary cationic surfactants include but are not limited to alkyl primary, secondary, and tertiary amines, alkanolamides, quaternary ammonium salts, alkylated imidazolium, and pyridinium salts. Additional examples of the cationic surfactant include primary to tertiary alkylamine salts such as, e.g., monostearylammonium chloride, distearylammonium chloride, tristearylammonium chloride; quaternary alkylammonium salts such as, e.g., monostearyltrimethylammonium chloride, distearyldimethylammonium chloride, stearyldimethylbenzylammonium chloride, monostearyl-bis(polyethoxy)methylammonium chloride; alkylpyridinium salts such as, e.g., N-cetylpyridinium chloride, N-stearylpyridinium chloride; N,N-dialkylmorpholinium salts; fatty acid amide salts such as, e.g., polyethylene polyamine; and the like.

Exemplary anionic surfactants include alkyl sulfates, alkyl sulfonates, fatty acids, sulfosuccinates, and phosphates. Examples of an anionic surfactant include anionic surfactants having a carboxyl group such as sodium salt of alkylcarboxylic acid, potassium salt of alkylcarboxylic acid, ammonium salt of alkylcarboxylic acid, sodium salt of alkylbenzenecarboxylic acid, potassium salt of alkylbenzenecarboxylic acid, ammonium salt of alkylbenzenecarboxylic acid, sodium salt of polyoxyalkylene alkyl ether carboxylic acid, potassium salt of polyoxyalkylene alkyl ether carboxylic acid, ammonium salt of polyoxyalkylene alkyl ether carboxylic acid, sodium salt of N-acylsarcosine acid, potassium salt of N-acylsarcosine acid, ammonium salt of N-acylsarcosine acid, sodium salt of N-acylglutamic acid, potassium salt of N-acylglutamic acid, ammonium salt of N-acylglutamic acid; anionic surfactants having a sulfonic acid group; anionic surfactants having a phosphonic acid; and the like.

The nonionic surfactant is, e.g., an ethoxylated fatty alcohols, alkyl phenol polyethoxylates, fatty acid esters, glycerol esters, glycol esters, polyethers, alkyl polyglycosides, amineoxides, or a combination thereof. Exemplary nonionic surfactants include fatty alcohols (e.g., cetyl alcohol, stearyl alcohol, cetostearyl alcohol, oleyl alcohol, and the like); polyoxyethylene glycol alkyl ethers (e.g., octaethylene glycol monododecyl ether, pentaethylene glycol monododecyl ether, and the like); polyoxypropylene glycol alkyl ethers (e.g., butapropylene glycol monononyl ethers); glucoside alkyl ethers (e.g., decyl glucoside, lauryl glucoside, octyl glucoside); polyoxyethylene glycol octylphenol ethers (e.g., Triton X-100 (octyl phenol ethoxylate)); polyoxyethylene glycol alkylphenol ethers (e.g., nonoxynol-9); glycerol alkyl esters (e.g., glyceryl laurate); polyoxyethylene glycol sorbitan alkyl esters (e.g., polysorbates such as sorbitan monolaurate, sorbitan monopalmitate, sorbitan monostearate, sorbitan tristearate, sorbitan monooleate, and the like); sorbitan alkyl esters (e.g., polyoxyethylene sorbitan monolaurate, polyoxyethylene sorbitan monopalmitate, polyoxyethylene sorbitan monostearate, polyoxyethylene sorbitan monooleate, and the like); cocamide ethanolamines (e.g., cocamide monoethanolamine, cocamide diethanolamine, and the like); amine oxides (e.g., dodecyldimethylamine oxide, tetradecyldimethylamine oxide, hexadecyl dimethylamine oxide, octadecylamine oxide, and the like); block copolymers of polyethylene glycol and polypropylene glycol (e.g., poloxamers available under the trade name Pluronics, available from BASF); polyethoxylated amines (e.g., polyethoxylated tallow amine); polyoxyethylene alkyl ethers such as polyoxyethylene stearyl ether; polyoxyethylene alkylene ethers such as polyoxyethylene oleyl ether; polyoxyalkylene alkylphenyl ethers such as polyoxyethylene nonylphenyl ether; polyoxyalkylene glycols such as polyoxypropylene polyoxyethylene glycol; polyoxyethylene monoalkylates such as polyoxyethylene monostearate; bispolyoxyethylene alkylamines such as bispolyoxyethylene stearylamine; bispolyoxyethylene alkylamides such as bispolyoxyethylene stearylamide; alkylamine oxides such as N,N-dimethylalkylamine oxide; and the like.

Zwitterionic surfactants (which include a cationic and anionic functional group on the same molecule) include, e.g., betaines, such as alkyl ammonium carboxylates (e.g., [CH₃)₃N⁺—CH(R)COO⁻] or sulfonates (sulfo-betaines) such as [RN⁺(CH₃)₂(CH₂)₃SO_{3-]}, where R is an alkyl group). Examples include n-dodecyl-N-benzyl-N-methylglycine [C₁₂H₂₅N⁺(CH₂C₆H₅)(CH₃)CH₂COO⁻], N-allyl N-benzyl N-methyltaurines [CₙH₂ₙ₊₁N⁺(CH₂C₆H₅)(CH₃)CH₂CH₂SO₃⁻].

The treatment fluids contain about 0.5 vol. % to about 25 vol. %, about 1 vol. % percent to about 15 vol. %, or about 1 vol. % to about 10 vol. % of the dispersant, based on the total volume of the treatment fluids.

Hydrogen sulfide scavenger includes hydrogen peroxide, chlorine dioxide, sodium chlorite, ammonium bisulfate, glyoxal, glyoxal/surfactant mixtures, amine-aldehyde condensates, nitrites such as sodium nitrite, acrolein, formaldehyde, glutaraldehyde, chelating agents such as ammonium salts of ethylenediaminetetraacetic acid, hydroxyethylethylenediaminetriacetic acid, ammoniated-DPTA, a triazine based compound, zinc carboxylate oxo complexes, or any compound capable of releasing or generating formaldehyde under application conditions such as zinc formaldehyde sulfoxylate or sodium formaldehyde sulfoxylate, or a combination comprising at least one of the foregoing. In an embodiment, a hydrogen sulfide scavenger comprises a reaction product of glyoxal and a polyamine selected from the group consisting of triethylene tetramine (TETA), tetraethylene pentamine (TEPA), cyclohexane diamine, butane diamine, and combinations thereof. Zinc carboxylate oxo complexes are described in U.S. Pat. No. 9,353,026.

Hydrogen sulfide scavenger is present in the treatment fluids in an amount of about 0.1 vol. % to about 10 vol. %, about 0.5 vol. % to about 5 vol. %, or about 1 vol. % to about 2 vol. %, based on the total volume of the treatment fluids.

Customized formulations of the treatment fluids can be formulated depending on the application temperature, type of metal to be contacted by the fluid system and type of metal sulfide deposits to be removed.

The treatment fluids can include an iron control agent. Suitable iron control agent may sequester or chelate dissolved iron preventing iron precipitate from forming. The iron control agent may comprise, for example, at least one of a reducing agent, an iron chelator, and an oxygen scavenger. Examples of iron control agent include thioglycolic acid, trisodium nitroacetate, citric acid, and copper sulfate pentahydrate.

In some embodiments, the iron control agent is present in an amount of about 0.1 vol. % to about 10 vol. %, about 0.5 vol. % to about 5 vol. %, or about 0.6 vol. % to about 3 vol. %, based on the total volume of the treatment fluids.

Depending on the application temperature, the treatment fluids can further comprise a corrosion inhibitor. The corrosion inhibitor serves to reduce or prevent the corrosion of the treatment fluids on metal surfaces and equipment, for example, completion equipment, pipelines, downhole casing and tubing, or even mineral surface in the formation.

The corrosion inhibitor comprises alkyl sarcosinates; amines; acetylenic alcohols; quaternary salts; fluorinated surfactants; aldehydes; chromates; nitrites; phosphates; hydrazines; amides; imines; condensation products of an aldehyde, a carbonyl containing compound; ethoxylated alcohols; unsaturated carbonyl compounds; unsaturated ether compounds; heavy oil derivatives; or a combination comprising at least one of the foregoing. Exemplary amines include hexamine, phenylenediamine, dimethylethanolamine, quaternary amines or quaternary ammoniums such as a quinoline quaternary amine. Nitrites include sodium nitrite. Exemplary aldehyde includes cinnamaldehyde. Exemplary amides include formamide. Ethoxylated alcohols include ethoxylated nonylphenol.

In an embodiment, the alkyl sarcosinates have the chemical formula

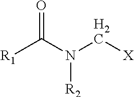

wherein R₁hydrophobic chain having about 12 to about 24 carbon atoms, R₂ is hydrogen, methyl, ethyl, propyl, or butyl, and X is carboxyl or sulfonyl. The hydrophobic chain can be an alkyl, alkenyl, alkylarylalkyl, or alkoxyalkyl group. The hydrophobic chain can be branched or straight chained. Representative long chain alkyl groups include, but are not limited to, tetradecyl, hexadecyl, octadecentyl (oleyl), octadecyl (stearyl), and docosenoic functionalities.

One suitable alkyl sarcosinate is an anionic sarcosinate surfactant available commercially from Baker Hughes Incorporated as “M-Aquatrol” (MA). The MA-1 sarcosinate is a viscous liquid surfactant with at least 94% oleoyl sarcosine. Detailed description of alkyl sarcosinate can be found in U.S. Pat. No. 8,357,640.

The corrosion inhibitor can be present in the fluid system in an amount of about 1 gpt to about 30 gpt, specifically about 1 gpt to about 20 gpt, and more specifically about 1 to about 15 gpt by volume based on the total volume of the treatment fluids.

For application temperatures exceeding 250° F., a corrosion inhibitor intensifier may be used to aid to decrease the corrosion of the treatment fluids. A corrosion inhibitor intensifier is a chemical compound that itself does not inhibit corrosion, but enhances the effectiveness of a corrosion inhibitor over the effectiveness of the corrosion inhibitor without the corrosion inhibitor intensifier. Exemplary corrosion inhibitor intensifier incudes terpenes, formic acid, a metallic iodide salt such as potassium iodide, cuprous chloride, antimony-based compounds, bismuth-based compounds, an organic acid, or a combination comprising at least one of the foregoing.

The corrosion inhibitor intensifier can be present in an amount of greater than about 0.1% by volume of treatment fluids. In an embodiment, the corrosion inhibitor intensifier is present in an amount of about 0.1% to about 10% or about 0.1 to about 5% by volume of the treatment fluid.

The treatment fluids are an aqueous based fluids. In an embodiment, the treatment fluids comprise about 40 vol. % to about 90 vol. % or about 50 vol. % to about 80 wt. % of water. Water miscible organic solvent can also be present.

The treatment fluids described herein can effectively and efficiently remove metal sulfide deposits. The metal sulfide deposits comprise iron sulfide, zinc sulfide, or a combination thereof. Depending on factors such as the age of the scale, environmental temperature, and pressure, iron sulfides exist in several distinct forms with different crystalline structures, different ratios of sulfur to iron and different properties. The iron sulfide species that can be removed by the treatment fluids include FeS₂, FeS, Fe₇S₈, Fe₉S₈, or a combination thereof.

A method of removing a metal sulfide deposit from a surface comprises contacting the metal sulfide deposit with a treatment fluid comprising an alkane sulfonic acid, a dispersant, and a hydrogen sulfide scavenger for a sufficient amount to dissolve the metal sulfide deposit; and removing the metal sulfide deposit from the surface.

The treatment fluids disclosed herein are particularly useful to remove a metal sulfide deposit in a downhole environment. A method of removing metal sulfides from a downhole environment comprises introducing into a subsurface well a treatment fluid as described herein; contacting a metal sulfide deposit in the downhole environment with the treatment fluid; and removing the metal sulfide deposit from the downhole environment.

In an embodiment, the metal sulfide deposit is contacted with the treatment fluid for a time sufficient to dissolve the metal sulfide. For example, the metal sulfide deposit is contacted with the treatment fluid for at least about 10 minutes, or at least about 20 minutes. The metal sulfide deposit is contacted with the treatment fluid at an elevated temperature, such as a temperature of about 70° F. to about 350° F.

The treatment fluids can remove a metal sulfide deposit from any surface including a metallic surface. The downhole environment includes formation matrix, wellbore, casing, tubulars, pipes, valves, pumps, or any other equipment associated with the wellbore. In an embodiment, the treatment fluids remove metal sulfide deposits from a metallic surface. Such metallic surface can comprise steel.

The treatment fluids can be bullheaded or delivered through mechanical placement methods, including coiled tubing, in oil, gas, and geothermal wellbore tubulars, completions and reservoirs. Introducing the treatment fluid includes pumping the treatment fluid into a subsurface well. In an embodiment, the treatment fluid is introduced into the subsurface well through a conduit inserted into the wellbore. The conduit can be a drill string, a casing string, tubing string, coiled tubing or joined tubing. As used herein, coiled tubing refers to a very long metal pipe, which is normally supplied spooled on a large reel. Treatment fluids can be pumped through the coil and pushed into the wellbore rather than relying on gravity. Coiled tubing is not particularly limited and can include any coiled tubing known to a person skilled in the art.

Removing the metal sulfide deposit from the downhole environment includes allowing the treatment fluids to flow back to the surface of the well. In an embodiment, the method further comprises receiving a returning fluid comprising a dissolved sulfide at the surface of the wellbore from an annular space between the conduit and a wall of the wellbore.

The treatment fluids can be used as a stand-alone treatment for dissolution of metal sulfide deposits and/or can be used as part of a stimulation treatment in oil, gas, and geothermal reservoirs and/or as part of a cleaning treatment in oil, gas, and water vapor pipelines.

Set forth below are various embodiments of the disclosure.

Embodiment 1. A method of removing a metal sulfide deposit from a surface, the method comprising: contacting the metal sulfide deposit with a treatment fluid comprising an alkane sulfonic acid, a dispersant, and a hydrogen sulfide scavenger for a sufficient amount of time to dissolve the metal sulfide deposit; and removing the metal sulfide deposit from the surface.

Embodiment 2. A method of removing a metal sulfide deposit from a downhole environment, the method comprising: introducing into a subsurface well a treatment fluid comprising an alkane sulfonic acid, a dispersant, and a hydrogen sulfide scavenger; contacting the metal sulfide deposit in the downhole environment with the treatment fluid; and removing the metal sulfide deposit from the downhole environment

Embodiment 3. The method as in any prior embodiment, wherein the alkane sulfonic acid has a formula of R—SO3H, wherein R is a straight chain, branched, or cyclic C1-6 alkyl. In an exemplary embodiment, the alkane sulfonic acid comprises methanesulfonic acid.

Embodiment 4. The method as in any prior embodiment, wherein the dispersant is effective to disperse water insoluble particulates in the treatment fluid to prevent the water insoluble particulates from settling out of the treatment fluid.

Embodiment 5. The method as in any prior embodiment, wherein the hydrogen sulfide scavenger comprises one or more of the following: hydrogen peroxide; chlorine dioxide; sodium chlorite; ammonium bisulfite; glyoxal; a glyoxal/surfactant mixture; an amine-aldehyde condensate; a nitrite; acrolein; formaldehyde or a compound capable of releasing or generating formaldehyde under application conditions; glutaraldehyde; an ammonium salt of ethylenediaminetetraacetic acid; an ammonium salt of hydroxyethylethylenediaminetriacetic acid; an ammoniated-DPTA; a triazine based compound; or a zinc carboxylate oxo complex.

Embodiment 6. The method as in any prior embodiment, wherein the metal sulfide deposit comprises iron sulfide, zinc sulfide, or a combination thereof.

Embodiment 7. The method as in any prior embodiment, wherein the treatment fluid further comprises an iron control agent, and the iron control agent comprises thioglycolic acid; trisodium nitroacetate; citric acid; copper sulfate pentahydrate; or a combination comprising at least one of the foregoing.

Embodiment 8. The method as in any prior embodiment, wherein the treatment fluid further comprises a corrosion inhibitor, and the corrosion inhibitor comprises one or more of the following: alkyl sarcosinates; amines; acetylenic alcohols; quaternary salts; fluorinated surfactants; aldehydes; chromates; nitrites; phosphates; hydrazines; amides; imines; condensation products of an aldehyde, a carbonyl containing compound; ethoxylated alcohols; unsaturated carbonyl compounds; unsaturated ether compounds; or heavy oil derivatives.

Embodiment 9. The method as in any prior embodiment, wherein the treatment fluid further comprises a corrosion intensifier, the corrosion intensifier comprising one or more of the following: a terpene; formic acid; a metallic iodide salt such as potassium iodide; cuprous chloride; an antimony-based compound; a bismuth-based compound; or an organic acid.

Embodiment 10. The method as in any prior embodiment, wherein the treatment fluid is an aqueous-based fluid.

Embodiment 11. The method as in any prior embodiment, wherein the treatment fluid comprises about 10 to about 50 volume percent of the alkane sulfonic acid; about 0.5 to about 25 volume percent of the dispersant; and about 0.1 to about 10 volume percent of the hydrogen sulfide scavenger, each based on the total volume of the treatment fluid.

Embodiment 12. The method as in any prior embodiment, wherein the metal sulfide deposit is contacted with the treatment fluid for at least about 10 minutes.

Embodiment 13. The method as in any prior embodiment, wherein the metal sulfide deposit is contacted with the treatment fluid at a temperature of about 70° F. to about 350° F.

Embodiment 14. The method as in any prior embodiment, wherein the treatment fluid is introduced into the subsurface well through a conduit inserted into the well. The conduit comprises a drilling string, casing string, tubing string, joined tubing, or coiled tubing.

Embodiment 15. The method as in any prior embodiment, further comprising receiving a returning fluid comprising a dissolved sulfide at the surface of the wellbore from an annular space between the conduit and a wall of the wellbore.

Embodiment 16. The method as in any prior embodiment, wherein removing the metal sulfide deposit is a stand-alone operation.

Embodiment 17. The method as in any prior embodiment, wherein removing the metal sulfide deposit is part of a stimulation operation or a cleaning operation.

Embodiment 18. A metal sulfide treatment fluid comprising about 10 vol. % to about 50 vol. % of an alkane sulfonic acid; about 0.5 vol. % to about 25 vol. % of a dispersant; and about 0.1 vol. % to about 10 vol. % of a hydrogen sulfide scavenger.

Embodiment 19. The metal sulfide treatment fluid as in any prior embodiment, further comprising one or more of following: an iron control agent; a corrosion inhibitor; or a corrosion inhibitor intensifier.

Embodiment 20. The metal sulfide treatment fluid as in any prior embodiment comprising about 0.1 vol. % to about 10 vol. % of the iron control agent based on the total volume of the metal sulfide treatment fluid.

All ranges disclosed herein are inclusive of the endpoints, and the endpoints are independently combinable with each other. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” The modifier “about” used in connection with a quantity is inclusive of the stated value and has the meaning dictated by the context (e.g., it includes the degree of error associated with measurement of the particular quantity).

1. A method of removing a metal sulfide deposit from a surface, the method comprising: contacting the metal sulfide deposit with a treatment fluid comprising an alkane sulfonic acid, a dispersant, and a hydrogen sulfide scavenger for a sufficient amount of time to dissolve the metal sulfide deposit; and removing the metal sulfide deposit from the surface.

2. A method of removing a metal sulfide deposit from a downhole environment, the method comprising: introducing into a subsurface well a treatment fluid comprising an alkane sulfonic acid, a dispersant, and a hydrogen sulfide scavenger; contacting the metal sulfide deposit in the downhole environment with the treatment fluid; and removing the metal sulfide deposit from the downhole environment

3. The method of claim 1, wherein the alkane sulfonic acid has a formula of R—SO₃H, wherein R is a straight chain, branched, or cyclic C1-6 alkyl.

4. The method of claim 3, wherein the alkane sulfonic acid comprises methanesulfonic acid.

5. The method of claim 1, wherein the dispersant is effective to disperse water insoluble particulates in the treatment fluid to prevent the water insoluble particulates from settling out of the treatment fluid.

6. The method of claim 1, wherein the hydrogen sulfide scavenger comprises one or more of the following: hydrogen peroxide; chlorine dioxide; sodium chlorite; ammonium bisulfite; glyoxal; a glyoxal/surfactant mixture; an amine-aldehyde condensate; a nitrite; acrolein; formaldehyde or a compound capable of releasing or generating formaldehyde under application conditions; glutaraldehyde; an ammonium salt of ethylenediaminetetraacetic acid; an ammonium salt of hydroxyethylethylenediaminetriacetic acid; an ammoniated-DPTA; a triazine based compound; or a zinc carboxylate oxo complex.

7. The method of claim 1, wherein the metal sulfide deposit comprises iron sulfide, zinc sulfide, or a combination thereof.

8. The method of claim 1, wherein the treatment fluid further comprises an iron control agent, the iron control agent comprising thioglycolic acid; trisodium nitroacetate; citric acid; copper sulfate pentahydrate; or a combination comprising at least one of the foregoing.

9. The method of claim 1, wherein the treatment fluid further comprises a corrosion inhibitor, the corrosion inhibitor comprising one or more of the following: alkyl sarcosinates; amines; acetylenic alcohols; quaternary salts; fluorinated surfactants; aldehydes; chromates; nitrites; phosphates; hydrazines; amides; imines; condensation products of an aldehyde, a carbonyl containing compound; ethoxylated alcohols; unsaturated carbonyl compounds; unsaturated ether compounds; or heavy oil derivatives.

10. The method of claim 9, wherein the treatment fluid further comprises a corrosion intensifier, the corrosion intensifier comprising one or more of the following: a terpene; formic acid; a metallic iodide salt such as potassium iodide; cuprous chloride; an antimony-based compound; a bismuth-based compound; or an organic acid.

11. The method of claim 1, wherein the treatment fluid comprises about 10 to about 50 volume percent of the alkane sulfonic acid; about 0.5 to about 25 volume percent of the dispersant; and about 0.1 to about 10 volume percent of the hydrogen sulfide scavenger, each based on the total volume of the treatment fluid.

12. The method of claim 1, wherein the metal sulfide deposit is contacted with the treatment fluid at a temperature of about 70° F. to about 350° F.

13. The method of claim 2, wherein the treatment fluid is introduced into the subsurface well through a conduit inserted into the wellbore.

14. A metal sulfide treatment fluid comprising about 10 vol. % to about 50 vol. % of an alkane sulfonic acid; about 0.5 vol. % to about 25 vol. % of a dispersant; and about 0.1 vol. % to about 10 vol. % of a hydrogen sulfide scavenger.

15. The metal sulfide treatment fluid of claim 14, further comprising one or more of following: an iron control agent; a corrosion inhibitor; or a corrosion inhibitor intensifier.

16. The method of claim 2, wherein the alkane sulfonic acid has a formula of R—SO3H, wherein R is a straight chain, branched, or cyclic C1-6 alkyl.

17. The method of claim 16, wherein the alkane sulfonic acid comprises methanesulfonic acid.

18. The method of claim 2, wherein the hydrogen sulfide scavenger comprises one or more of the following: hydrogen peroxide; chlorine dioxide; sodium chlorite; ammonium bisulfite; glyoxal; a glyoxal/surfactant mixture; an amine-aldehyde condensate; a nitrite; acrolein; formaldehyde or a compound capable of releasing or generating formaldehyde under application conditions; glutaraldehyde; an ammonium salt of ethylenediaminetetraacetic acid; an ammonium salt of hydroxyethylethylenediaminetriacetic acid; an ammoniated-DPTA; a triazine based compound; or a zinc carboxylate oxo complex.

19. The method of claim 2, wherein the treatment fluid further comprises an iron control agent, the iron control agent comprising thioglycolic acid; trisodium nitroacetate; citric acid; copper sulfate pentahydrate; or a combination comprising at least one of the foregoing.

20. The method of claim 2, wherein the treatment fluid comprises about 10 to about 50 volume percent of the alkane sulfonic acid; about 0.5 to about 25 volume percent of the dispersant; and about 0.1 to about 10 volume percent of the hydrogen sulfide scavenger, each based on the total volume of the treatment fluid.
